(19) United States
(12) Patent Application Publication
(10) Pub. No.: US 2010/0049996 A1
(43) Pub. Date: Feb. 25, 2010

(54) LOAD DETECTING SYSTEM AND METHOD

(75) Inventors: DE-YUAN DONG, Shenzhen City (CN); DONG-HAI XUE, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/250,495

(22) Filed: Oct. 13, 2008

(30) Foreign Application Priority Data
Aug. 20, 2008 (CN) 200810304113.5

(51) Int. Cl. G06F 1/00

(52) U.S. Cl. 713/300

(57) ABSTRACT

A load detecting system includes a chipset connected to a hardware unit and an interrupt controller connected to the chipset. A maximum voltage value and a minimum voltage value of the hardware unit are stored in the chipset. The chipset is configured to detect a voltage signal of the hardware, and compare the voltage signal to the maximum voltage and the minimum voltage values to output an interrupt signal to the interrupt controller correspondingly. The interrupt controller is configured to adjust work frequency of the hardware unit according to the interrupt signal.

### BACKGROUND

1. Field of the Invention

Embodiments of the present disclosure relate to electronic loads, and more particularly to a load detecting system and method.

2. Description of the Related Art

Running a processor in a device, such as a computer, at high clock speeds allows for better performance. However, when the same processor is run at a lower frequency, it generates less heat and consumes less power. In many cases, the core voltage of the processor can also be reduced, further reducing power consumption and heat generation. This can conserve battery power in notebooks, extend processor life, and reduce noise generated by variable-speed fans.

At the present time, a software module is used to detect a load on the processor, and users can adjust the core voltage to consume less power. However, the software module consumes additional resources of the computer.

Therefore, what is needed, is a load detecting system and method which can save resources.

### BRIEF DESCRIPTION OF THE DRAWINGS

FIG. 1 is a block diagram of one embodiment of a load detecting system of the present disclosure.

FIG. 2 is a flowchart of an embodiment of a load detecting method.

### DETAILED DESCRIPTION

As used herein, the term “load” is defined to include a workload of a processor executing one or more computerized instructions. It may be understood that the load may increase as the processor executes additional tasks and/or a frequency of the processor is increased.

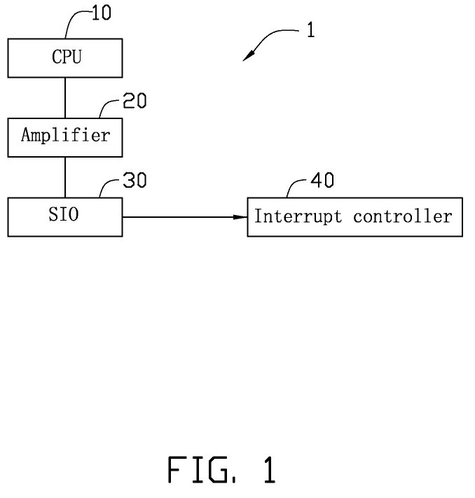

Referring to FIG. 1, one embodiment of a load detecting system 1 is configured to detect a load of a central processing unit (CPU) 10, and includes an amplifier 20, a super input/output device (SIO) 30, an interrupt controller 40, and a basic input output system (BIOS) (not shown). The SIO 30 includes a voltage sensor (not shown) and a memory system (not shown). The interrupt controller 40 is integrated in a south bridge of a motherboard.

An input of the amplifier 20 is connected to a voltage output of the CPU 10 to receive a voltage signal from the CPU 10, and output an amplified voltage signal Vin. An output of the amplifier 20 is connected to the SIO 30 to output the amplified voltage signal Vin to the SIO 30. The BIOS is configured to store values representing a maximum voltage Vhigh and a minimum voltage Vlow in the memory system of the SIO 30. The voltage sensor of the SIO 30 is configured to compare the amplified voltage signal Vin to the maximum voltage Vhigh and the minimum voltage Vlow. When the amplified voltage signal Vin is more than the maximum voltage Vhigh, an interrupt pin of the SIO 30 outputs an interrupt signal to the interrupt controller 40 to activate a program that will raise a work frequency of the CPU 10. When the amplified voltage signal Vin is less than the minimum voltage Vlow, the interrupt pin of the SIO 30 outputs another interrupt signal to the interrupt controller 40 to activate another program that will lower a work frequency of the CPU 10.

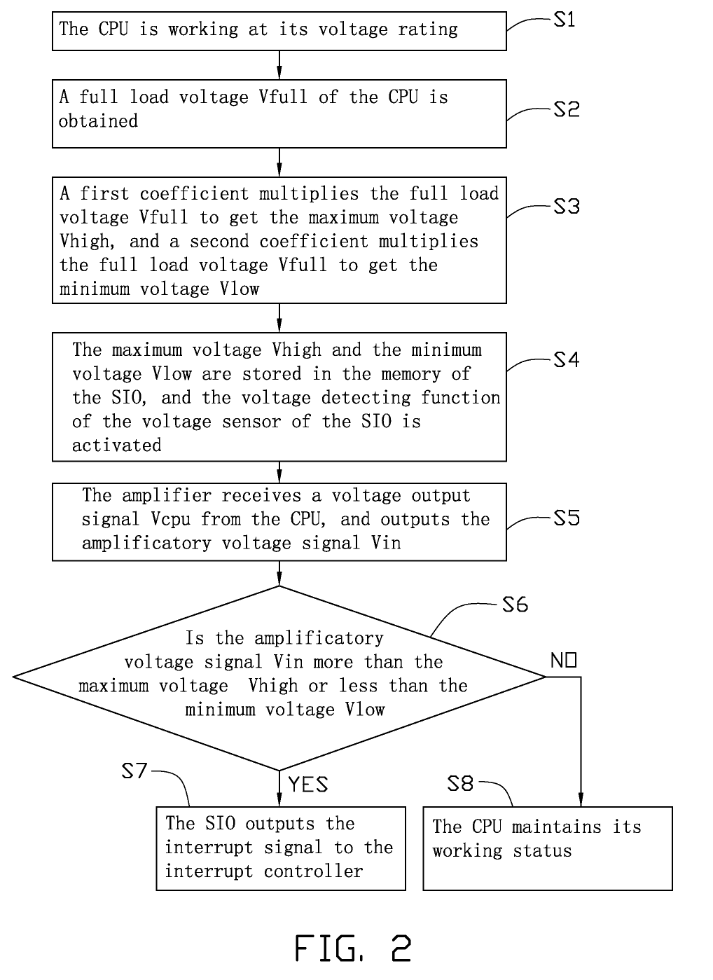

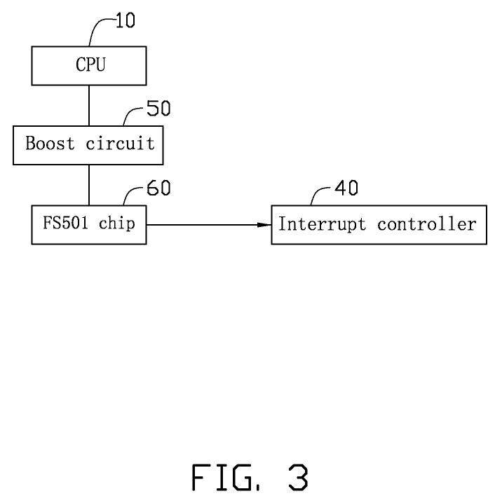

FIG. 2 is a flowchart of one embodiment of a load detecting method using the above mentioned system. Depending on the embodiment, certain blocks described below may be removed, others may be added, and the sequence of the blocks may be altered.

In block S1, the CPU 10 is working at a voltage rating. In other words, power of the CPU 10 is equal to its rated power at this time.

In block S2, a full load voltage Vfull of the CPU 10 is obtained by the SIO 30.

In block S3, the full load voltage Vfull is multiplied by a first coefficient to determine the maximum voltage Vhigh, and the full load voltage Vfull is then multiplied by a second coefficient to determine the minimum voltage Vlow. The first coefficient may range between 0.95 to 1, the second coefficient may range between about 0.90 to about 0.95, but not equal to the first coefficient.

In block S4, the maximum voltage Vhigh and the minimum voltage Vlow values are stored in the memory system of the SIO 30, and the voltage detecting function of the voltage sensor of the SIO 30 is activated.

In block S5, the amplifier 20 receives a voltage output signal Vcpu from the CPU 10, and outputs the amplified voltage signal Vin.

In block S6, the SIO 30 receives the amplified voltage signal Vin from the amplifier 20, and compares the amplified voltage signal Vin to the maximum voltage Vhigh and the minimum voltage Vlow values.

In block S7, if the amplified voltage signal Vin is more than the maximum voltage Vhigh value or less than the minimum voltage Vlow value, the SIO 30 outputs an interrupt signal to the interrupt controller 40. The interrupt controller 40 activates the program that will raise or lower work frequency of the CPU 10 correspondingly.

In block S8, if the amplified voltage signal Vin is between the maximum voltage Vhigh value and the minimum voltage Vlow value, no interrupt signal is output by the SIO 30, and the CPU 10 maintains its working status. In other words, work frequency of the CPU 10 remains the same.

In the current embodiment, the amplifier 20 can be replaced by a step-up circuit such as a boost circuit 50 (see in FIG. 3). Furthermore, if a range of the voltage output signal Vcpu of the CPU 10 is more than a selected value, the amplifier 20 can be omitted. The selected value may be predetermined or user editable depending on the embodiment. The SIO 30 can be replaced by a FS501 chip 60 of the Fortune corporation, which is configured for detecting a voltage, comparing the voltage to a value, and activating an interrupt process (see in FIG. 3). The load detecting system 1 is also configured to detect loading of other hardware units.

The foregoing description of the various inventive embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others of ordinary skill in the art to utilize the disclosure and various embodiments and with various modifications as are suited to the particular use contemplated. Alternately embodiments will become apparent to those of ordinary skill in the art to which the present disclosure pertains without departing from its spirit and scope. Accordingly, the scope of the present disclosure is defined by the appended claims rather than the foregoing description and the various inventive embodiments described therein.

What is claimed is:

1. A load detecting system for detecting a load of a hardware unit, the load detecting system comprising:
a chipset connected to the hardware unit;
an interrupt controller connected to the chipset, wherein a maximum voltage value and a minimum voltage value of the hardware unit are stored in the chipset;
wherein the chipset is configured to detect a voltage signal of the hardware unit and compare the voltage signal to the maximum voltage value and the minimum voltage value to output an interrupt signal to the interrupt controller correspondingly, wherein the interrupt controller is configured to adjust work frequency of the hardware unit according to the interrupt signal.

2. The load detecting system of claim 1, further comprising an amplifier connected between the hardware unit and the chipset, wherein the amplifier is configured to amplify the voltage signal from the hardware unit to get an amplified voltage signal and output the amplified voltage signal to the chipset.

3. The load detecting system of claim 1, further comprising a step-up circuit connected between the hardware unit and the chipset, wherein the step-up circuit is configured to amplify the voltage signal from the hardware unit to get an amplified voltage signal and output the amplified voltage signal to the chipset.

4. The load detecting system of claim 1, wherein the maximum voltage is equal to a product of a full load voltage of the hardware unit and a first coefficient, the minimum voltage is equal to a product of the full load voltage and a second coefficient, the full load voltage of the hardware unit is equal to an input voltage of the chipset in response to when the hardware unit is working at a maximum voltage rating of the hardware, wherein the first coefficient ranges between about 0.95 to about 1, the second coefficient ranges between about 0.9 to about 0.95, but is not equal to the first coefficient.

5. The load detecting system of claim 1, wherein the maximum voltage and the minimum voltage values are stored in a memory system of the chipset.

6. The load detecting system of claim 1, wherein the chipset is a super input output device.

7. The load detecting system of claim 1, wherein the chipset is a FS501 type chipset.

8. The load detecting system of claim 1, wherein the hardware unit is a central processing unit.

9. A load detecting method for detecting load of a hardware unit, the method comprising:
activating a voltage detecting function of a chipset to detect an output voltage value of the hardware unit;
comparing the output voltage value of the hardware unit to a maximum voltage value and a minimum voltage value of the hardware unit;
in response that the output voltage value of the hardware unit is more than the maximum voltage value or less than the minimum voltage value, the chipset outputs an interrupt signal to the interrupt controller to adjust work frequency of the hardware unit correspondingly; and
in response that the output voltage value of the hardware unit is between the maximum voltage and the minimum voltage values, the hardware unit maintains its work frequency.

10. The load detecting method of claim 9, wherein before the activating step comprises:
obtaining the maximum voltage value and the minimum voltage value of the hardware unit; and
storing the maximum voltage value and the minimum voltage value of the hardware unit in a memory system of the chipset.

11. The load detecting method of claim 10, wherein the obtaining step comprises:
making the hardware unit work at its voltage rating;
recording an input voltage of the chipset, wherein the input voltage being equal to a full voltage of the hardware unit; and
multiplying the full voltage of the hardware unit with a first coefficient to determine the maximum voltage of the hardware, and multiplying the full voltage of the hardware unit with a second coefficient to determine the minimum voltage of the hardware unit; wherein the first coefficient ranges between about 0.95 to about 1, the second coefficient ranges between about 0.9 to about 0.95, but being not equal to the first coefficient.

12. The load detecting method of claim 9, wherein the load detecting system further comprises an amplifier connected between the hardware unit and the chipset, after the activating step comprises:
amplifying the output voltage signal of the hardware unit and outputting the output signal to the chipset.

13. The load detecting method of claim 9, wherein the chipset is a super input output device.

14. The load detecting method of claim 9, wherein the chipset is a FS501 type chipset.

15. The load detecting method of claim 9, wherein the hardware unit is a central processing unit.
